(19) United States
(12) Patent Application Publication
(10) Pub. No.: US 2018/0246369 A1
(43) Pub. Date: Aug. 30, 2018

(54) Liquid Crystal Display Panel, Manufacturing Method Thereof and Display Device

(71) Applicants: BOE Technology Group Co., Ltd., Beijing (CN); Hefei BOE Optoelectronics Technology Co., Ltd., Hefei (CN)

(72) Inventor: Shiqiang Huang, Beijing (CN)

(73) Assignees: BOE Technology Group Co., Ltd., Beijing (CN); Hefei BOE Optoelectronics Technology Co., Ltd., Hefei (CN)

(21) Appl. No.: 15/558,422

(22) PCT Filed: Mar. 16, 2017
(86) PCT No.: PCT/CN2017/076919

§ 371 Date: Sep. 14, 2017

(30) Foreign Application Priority Data
Jul. 11, 2016 (CN) 201610543701.9

(51) Int. Cl. G02F 1/1335; G02F 1/1343; G02F 1/1345; G02F 1/1362; G02F 1/1339

(52) U.S. Cl. CPC G02F 1/133512; G02F 1/134363; G02F 1/1345; G02F 2202/22; G02F 1/1339; G02F 2202/16; G02F 1/136204

(57) ABSTRACT

Embodiments of the present invention relate to a liquid crystal display (LCD) panel, a manufacturing method thereof and a display device. The LCD panel includes an array substrate and an opposed substrate arranged opposite to the array substrate. The array substrate includes a first base substrate and a common electrode pattern disposed on the first base substrate; the opposed substrate includes a second base substrate and a black matrix pattern disposed on the second base substrate; and the common electrode pattern is electrically connected with the BM pattern. Thus, the LCD panel can avoid the interference of electrifying of the BM pattern on liquid crystal arrangement, and solve the problem of abnormal color or flicker of an image of the LCD panel caused by electrifying of the BM pattern.

### TECHNICAL FIELD

Embodiments of the present invention relate to a liquid crystal display (LCD) panel, a manufacturing method thereof and a display device.

### BACKGROUND

With the continuous development of the display device market, a liquid crystal display (LCD) has become a mainstream display device due to advantages of rapid response speed, high integration, low power consumption, etc. An LCD panel generally comprises a liquid crystal cell including an array substrate provided with a thin-film transistor (TFT) and an opposed substrate cell-assembled, and a liquid crystal molecule layer filled in the liquid crystal cell.

A black matrix is an important component in the LCD. The basic function of the black matrix (BM) is to shield light, so as to improve the contrast, avoid the color blending of adjacent subpixels, reduce the reflection of ambient light, and prevent the leakage current caused by the irradiation of the ambient light on an active layer of the TFT element. In general, in order to obtain good light shielding effect, the black matrix must have high optical density (OD), so the black matrix are usually made from materials such as chromium (Cr) metal or black materials (e.g., carbon (C)).

### SUMMARY

At least one embodiment of the present disclosure provides a liquid crystal display (LCD) panel, a manufacturing method thereof and a display device. The liquid crystal display (LCD) panel, comprises: an array substrate, including a first base substrate and a common electrode pattern disposed on the first base substrate; and an opposed substrate, arranged opposite to the array substrate and including a second base substrate and a black matrix (BM) pattern disposed on the second base substrate, wherein the common electrode pattern is electrically connected with the BM pattern. Thus, the LCD panel can avoid the influence of electrifying of the BM pattern on liquid crystal arrangement.

At least one embodiment of the present disclosure provides a liquid crystal display (LCD) panel, comprises: an array substrate, including a first base substrate and a common electrode pattern disposed on the first base substrate; and an opposed substrate, arranged opposite to the array substrate and including a second base substrate and a black matrix (BM) pattern disposed on the second base substrate, wherein the common electrode pattern is electrically connected with the BM pattern. Thus, the LCD panel can avoid the influence of electrifying of the BM pattern on liquid crystal arrangement.

For example, in the liquid crystal display (LCD) panel provided by an embodiment of the present invention, materials of the BM pattern include conductive materials.

For example, in the liquid crystal display (LCD) panel provided by an embodiment of the present invention, the array substrate further includes a pixel electrode pattern disposed on the first base substrate and an insulating layer disposed between the common electrode pattern and the pixel electrode pattern, and a common electrode is disposed on a side of the insulating layer close to the opposed substrate.

For example, in the liquid crystal display (LCD) panel provided by an embodiment of the present invention, the LCD panel includes a display region and a peripheral region disposed at a periphery of the display region; and the LCD panel further comprises: a sealant, disposed between the array substrate and the opposed substrate in the peripheral region, wherein the sealant includes a conductive structure, and the common electrode pattern is electrically connected with the BM through the conductive structure.

For example, in the liquid crystal display (LCD) panel provided by an embodiment of the present invention, the conductive structure is a conductive metal ball.

For example, in the liquid crystal display (LCD) panel provided by an embodiment of the present invention, the conductive metal ball is a gold (Au) ball.

For example, in the liquid crystal display (LCD) panel provided by an embodiment of the present invention, the common electrode pattern includes a common electrode and a common electrode line, and the common electrode line is electrically connected with the BM through the conductive structure.

For example, in the liquid crystal display (LCD) panel provided by an embodiment of the present invention, a shortest distance between an outer edge of the BM pattern in the peripheral region and an outer edge of the opposed substrate is greater than 0 and less than or equal to 0.15 mm.

For example, in the liquid crystal display (LCD) panel provided by an embodiment of the present invention, the opposed substrate further includes a transparent conductive layer disposed on a side of the second base substrate away from the array substrate, the first base substrate also includes a ground terminal, the LCD panel further comprises a conductive adhesive disposed on surrounding edges of the opposed substrate and the array substrate, and the transparent conductive layer is connected with the ground terminal through the conductive adhesive.

For example, in the liquid crystal display (LCD) panel provided by an embodiment of the present invention, the opposed substrate further includes: a covering layer disposed on the BM pattern, wherein in the peripheral region, the covering layer is provided with a through hole or is completely removed to expose the BM pattern.

At least one embodiment of the present disclosure provides a method for manufacturing an LCD panel, comprising: providing an array substrate, the array substrate includes a first base substrate and a common electrode pattern disposed on the first base substrate; providing an opposed substrate, the opposed substrate includes a second base substrate and a BM pattern disposed on the second base substrate; and cell-assembling the array substrate and the opposed substrate, and electrically connecting the common electrode pattern and the BM pattern.

For example, in the method for manufacturing an LCD panel provided by an embodiment of the present invention, the LCD panel includes a display region and a peripheral region disposed at a periphery of the display region, and the manufacturing method further comprises: coating a sealant on the peripheral regions of the array substrate and the opposed substrate to seal a liquid crystal cell formed by the array substrate and the opposed substrate, wherein the sealant includes a conductive structure, and the common electrode pattern is electrically connected with the BM through the conductive structure.

For example, in the method for manufacturing an LCD panel provided by an embodiment of the present invention, the conductive structure is a conductive metal ball.

For example, in the method for manufacturing an LCD panel provided by an embodiment of the present invention, the conductive metal ball is an Au ball.

For example, in the method for manufacturing an LCD panel provided by an embodiment of the present invention, a covering layer is disposed on a side of the BM pattern close to the array substrate, and the manufacturing method comprises: etching the covering layer in the peripheral region to expose the BM pattern.

For example, in the method for manufacturing an LCD panel provided by an embodiment of the present invention, the array substrate further includes a pixel electrode pattern disposed on the first base substrate and an insulating layer disposed between the pixel electrode pattern and the common electrode pattern, and a common electrode is disposed on a side of the insulating layer close to the opposed substrate.

For example, the method for manufacturing an LCD panel provided by an embodiment of the present invention, further comprising: cutting a peripheral part of the BM pattern, wherein a shortest distance between an outer edge of the BM pattern obtained after cutting and an outer edge of the opposed substrate is greater than 0 and less than or equal to 0.15 mm.

For example, the method for manufacturing an LCD panel provided by an embodiment of the present invention, further comprising: forming a transparent conductive layer on a side of the second base substrate away from the array substrate; forming a ground terminal on the array substrate; and coating a conductive adhesive on surrounding edges of the array substrate and the opposed substrate to connect the transparent conductive layer and the ground terminal.

At least one embodiment of the present disclosure provides a display device, comprising the LCD panel as mentioned above.

### BRIEF DESCRIPTION OF THE DRAWINGS

In order to clearly illustrate the technical solution of the embodiments of the invention, the drawings of the embodiments will be briefly described in the following; it is obvious that the described drawings are only related to some embodiments of the invention and thus are not limitative of the invention.

FIG. 1 is a schematic sectional view of an LCD panel;

FIG. 2 is a schematic sectional view of another LCD panel;

FIG. 3 is a schematic sectional view of an LCD panel provided by one embodiment of the present invention;

FIG. 4 is a schematic sectional view of another LCD panel provided by one embodiment of the present invention; and

FIG. 5 is a flow diagram of a method for manufacturing an LCD panel, provided by one embodiment of the present invention.

### DETAILED DESCRIPTION

In order to make objects, technical details and advantages of the embodiments of the invention apparent, the technical solutions of the embodiment will be described in a clearly and fully understandable way in connection with the drawings related to the embodiments of the invention. It is obvious that the described embodiments are just a part but not all of the embodiments of the invention. Based on the described embodiments herein, those skilled in the art can obtain other embodiment(s), without any inventive work, which should be within the scope of the invention.

Unless otherwise defined, all the technical and scientific terms used herein have the same meanings as commonly understood by one of ordinary skill in the art to which the present disclosure belongs. The terms, such as “first,” “second,” or the like, which are used in the description and the claims of the present disclosure, are not intended to indicate any sequence, amount or importance, but for distinguishing various components. The terms, such as “comprise/comprising,” “include/including,” or the like are intended to specify that the elements or the objects stated before these terms encompass the elements or the objects and equivalents thereof listed after these terms, but not preclude other elements or objects. The terms, such as “connect/connecting/connected,” “couple/coupling/coupled” or the like, are not limited to a physical connection or mechanical connection, but may include an electrical connection/coupling, directly or indirectly. The terms, “on,” “under,” or the like are only used to indicate relative position relationship, and when the position of the object which is described is changed, the relative position relationship may be changed accordingly.

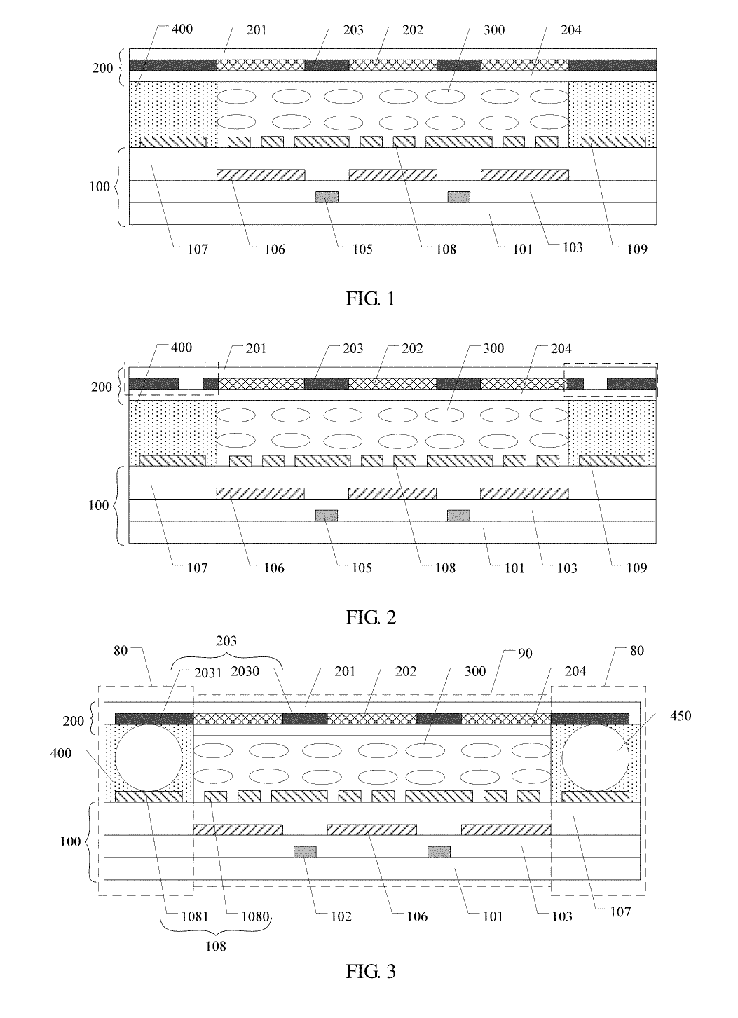

An inventor(s) of the present application finds in the study that: the BM made from materials such as Cr metal or black materials (e.g., C) have specific electric conductivity and is easy to be conductive or electrified. FIG. 1 is a schematic cross-sectional view of an LCD panel. The LCD panel comprises an array substrate 100, an opposed substrate 200 arranged opposite to the array substrate 100, and a liquid crystal layer 300 disposed between the array substrate 100 and the opposed substrate 200. As shown in FIG. 1, a narrow-bezel advanced super dimension switch (ADS) LCD panel usually adopts a black matrix edge cutting, namely edges of a black matrix 203 are aligned to edges of the array substrate 100 and the opposed substrate 200 after cutting. Therefore, the black matrix 203 is close to a periphery of the LCD panel and tend to be electrified due to the influence of outside static electricity or other conductive bodies, so electric potential difference may be produced between the black matrix and a common electrode 108 disposed on the array substrate 100, which interferes with an electric field formed between the common electrode 108 and a pixel electrode 106 and finally results in abnormal color or flicker of a display image.

In general, as shown in FIG. 2, a black matrix pattern 203 may be subjected to grooving (as shown by dotted lines in the figure), so that the BM pattern disposed in a peripheral region of the LCD panel can be isolated from the BM pattern disposed in a display region of the LCD panel, and hence the BM disposed in the display region will not be affected. That is to say, even the BM pattern disposed in the peripheral region of the LCD panel are electrified due to the influence of outside static electricity or other conductive bodies, the BM pattern disposed in the display region of the LCD panel are not electrified as being isolated from the BM pattern in the peripheral region of the LCD panel due to grooving. However, the solution may result in the risk of light leakage or peripheral red lines/blue lines of the LCD panel.

At least one embodiment of the present invention provides an LCD panel, a manufacturing method thereof and a display device. The LCD panel comprises an array substrate and an opposed substrate arranged opposite to the array substrate. The array substrate includes a first base substrate and a common electrode pattern disposed on the first base substrate; the opposed substrate includes a second base substrate and a BM pattern disposed on the second base substrate; and the common electrode pattern is electrically connected with the BM pattern. Thus, the LCD panel can avoid the interference of electrifying of the BM pattern on liquid crystal arrangement, and solve the problem of abnormal color or flicker of an image of the LCD panel due to electrifying of the BM pattern.

Description will be given below to the LCD panel, the manufacturing method thereof and the display device, provided by embodiments of the present invention, with reference to the accompanying drawings.

### A First Embodiment

The embodiment provides an LCD panel. As illustrated in FIG. 3, the LCD panel comprises: an array substrate 100, including a first base substrate 101 and a common electrode pattern 108 disposed on the first base substrate 101; and an opposed substrate 200, including a second base substrate 201 and a BM pattern 203 disposed on the second base substrate 201. The array substrate 100 and the opposed substrate 200 are arranged opposite to each other. The common electrode pattern 108 is electrically connected with the BM pattern 203.

In the LCD panel provided by the embodiment, the common electrode pattern 108 is electrically connected with the BM pattern 203, so the BM pattern 203 and the common electrode pattern 108 have same electric potential. That is to say, when a common electrode voltage is applied to the common electrode pattern 108, a voltage of the BM pattern 203 has the same potential with the common electrode voltage. Thus, no electric field will be produced between the BM pattern 203 and the common electrode pattern 108, so as to avoid the problem of abnormal color or flicker of an image of the LCD panel.

For instance, in the LCD panel provided by one example of the embodiment, materials of the BM pattern include conductive materials. For instance, the conductive materials may include C or Cr.

For instance, in the LCD panel provided by one example of the embodiment, as shown in FIG. 3, the array substrate 100 further includes a pixel electrode pattern 106 disposed on the first base substrate 101 and an insulating layer 107 disposed between the common electrode pattern 108 and the pixel electrode pattern 106. The common electrode pattern 108 are disposed on a side of the insulating layer 107 close to the opposed substrate 200, that is, as shown in FIG. 3, the common electrode pattern 108 is disposed above the pixel electrode patterns 106. When a common electrode voltage is applied to the common electrode pattern 108 and a pixel electrode voltage is applied to the pixel electrode pattern 106, there is an electric potential difference between the common electrode pattern 108 and the pixel electrode pattern 106, so an electric field are produced, a state of liquid crystal molecules in the liquid crystal layer 300 disposed between the array substrate 100 and the opposed substrate 200 can change, and hence an image can be displayed. As the common electrode pattern 108 is electrically connected with the BM pattern 203, the BM pattern 203 and the common electrode pattern 108 have the same electric potential, so the interference of the BM pattern 203 on the electric field between the common electrode pattern 108 and the pixel electrode pattern 106 can be avoided, and hence the problem of abnormal color or flicker of an image of the LCD panel can be prevented. In addition, as the common electrode pattern 108 is disposed on a side of the array substrate 100 close to the opposed substrate 200 and the BM pattern 203 is formed on the opposed substrate 200, the BM pattern 203 is far away from the pixel electrode pattern 106 and the common electrode pattern 108 are disposed between the BM pattern 203 and the pixel electrode pattern 106, so no electric field will be produced between the pixel electrode pattern 106 and the BM pattern 203 and the image display of the LCD panel will not be interfered.

For instance, in the LCD panel provided by one example of the embodiment, as shown in FIG. 3, the LCD panel comprises a display region 90 and a peripheral region 80 disposed at the periphery of the display region 90, and further comprises a sealant 400 disposed between the array substrate 100 and the opposed substrate 200 in the peripheral regions 80. The sealant 400 is configured to seal a liquid crystal cell formed by the array substrate 100 and the opposed substrate 200, and the liquid crystal cell is filled with liquid crystal molecules to form a liquid crystal layer 300. The sealant 400 includes a conductive structure 450. The common electrode pattern 108 and the BM pattern 203 are electrically connected with each other through the conductive structure 450. As shown in FIG. 3, the common electrode pattern 108 includes a common electrode 1080 and a common electrode line 1081 connected with the common electrode 1080; and the BM pattern 203 includes a peripheral BM 2031 disposed in the peripheral region 80 of the LCD panel and a display region BM 2030 disposed in the display region 90 of the LCD panel. The common electrode line 1081 and the peripheral BM 2031, disposed in the peripheral region 80 of the LCD panel, are connected with each other through the conductive structure 450 disposed in the sealant 400, so as to achieve the electrical connection between the BM pattern 203 and the common electrode pattern 108. When a common electrode voltage is applied to the common electrode line 1081, the common electrode 1080 and the display region BM 2030, disposed in the display region 90 of the LCD panel, have same electric potential, so no electric field will be produced between the display region BM 2030 and the common electrode 1080. Thus, the problem of abnormal color or flicker of an image of the LCD panel can be avoided. It should be noted that the embodiment of the present invention includes but not limited thereto, and the BM pattern and the common electrode pattern may also be electrically connected with each other by other means, for instance, connected with each other through a leading wire.

For instance, in the LCD panel provided by one example of the embodiment, as shown in FIG. 3, a range of a width of the peripheral region 80 is 0.5 mm-1.0 mm. For instance, the width of the peripheral region 80 is 0.8 mm. It should be noted that the width of the peripheral region refers to a distance from an edge of the display region to one side edge of the LCD panel.

For instance, in the LCD panel provided by one example of the embodiment, as shown in FIG. 3, the conductive structure 450 is a conductive metal ball.

For instance, the conductive metal ball is an Au ball, so the conductive structure has high electric conductivity.

For instance, in the LCD panel provided by one example of the embodiment, as shown in FIG. 3, the shortest distance between an outer edge of the BM pattern 203 disposed in the peripheral region 80 and an outer edge of the opposed substrate 200 is greater than 0 and less than or equal to 0.15 mm. Thus, there is certain distance between the BM pattern 203 and an edge of the LCD panel, so as to further avoid the interference of static electricity or conductive bodies from the outside. Moreover, as the distance from the BM pattern 203 to the edge of the LCD panel is shorter (less than or equal to 0.15 mm) and far less than the width of the peripheral region 80 (0.5 mm-1.0 mm), the display effect will not be affected.

For instance, in the LCD panel provided by one example of the embodiment, as shown in FIG. 3, the array substrate 100 further includes a data line 102 formed on the first base substrate 101 and a passivation layer 103 disposed on the first base substrate 101 and the data line 102. The pixel electrode pattern 106 is disposed on the passivation layer 103. It should be noted that the array substrate may further include a TFT (not shown in the figure) disposed on the first base substrate. The data line is electrically connected with a source electrode of the TFT, and the pixel electrode pattern is electrically connected with a drain electrode of the TFT, so display signals in the data line are applied to the pixel electrode pattern.

For instance, in the LCD panel provided by one example of the embodiment, as shown in FIG. 3, the opposed substrate 200 further includes: a covering layer 204 disposed on the BM pattern 203. The covering layer 204 is provided with a through hole or completely removed to expose the BM pattern 203 in the peripheral region 80 (namely a region provided with the sealant 400), so that the exposed BM pattern 203 can be connected with the common electrode pattern 108 through the conductive structure 450.

For instance, in the LCD panel provided by one example of the embodiment, as shown in FIG. 3, the opposed substrate 200 further includes a color filter (CF) pattern 202 disposed on the second base substrate 201, and the CF pattern 202 may be arranged in the same layer with the BM pattern 203. The CF pattern 202 is configured to convert light passing through the liquid crystal layer 300 into light having a color corresponding to the color of the CF pattern, so as to achieve a color display. It should be noted that the embodiment of the present invention includes but not limited thereto, and the CF pattern may also be not arranged in the same layer with the BM pattern.

In the LCD panel provided by one example of the embodiment, as shown in FIG. 3, the common electrode 1080 is provided with a plurality of slits directly over the pixel electrode pattern 106, so a horizontal electric field can be produced between the common electrode and the pixel electrode pattern 106 to drive the liquid crystal molecules to rotate. Moreover, directly above the data line 102, the common electrode 1080 is not provided with any slit, so as to avoid the influence of electric signals in the data line 102 on the liquid crystal molecules.

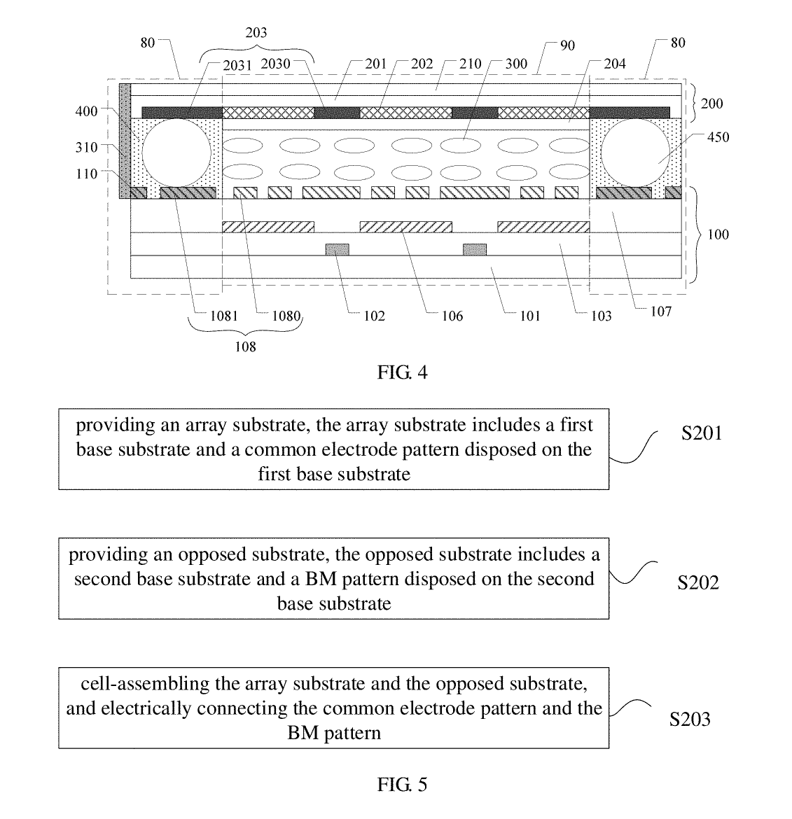

For instance, in the LCD panel provided by one example of the embodiment, as shown in FIG. 4, the opposed substrate 200 further includes a transparent conductive layer 210 disposed on a side of the second base substrate 202 away from the array substrate 100; the array substrate 100 further includes a ground terminal 110; the LCD panel further comprises a conductive adhesive 310 disposed on surrounding edges of the opposed substrate 200 and the array substrate 100; and the transparent conductive layer 210 is connected with the ground terminal 110 through the conductive adhesive 310. For instance, as shown in FIG. 4, the transparent conductive layer 210 is formed above the second base substrate 202, and an edge of the transparent conductive layer 210 is aligned with the edge of the second base substrate 202. The ground terminal 110 and lines such as the common electrode line 1081 are arranged in the same layer on the insulating layer 107 and disposed at an edge of the peripheral region 80, so the ground terminal 110 and the transparent conductive layer 210 can be connected with each other through the conductive adhesive 310 disposed on surrounding edges of the opposed substrate 200 and the array substrate 100. When static electricity or a conductive body makes contact with the LCD panel provided by the embodiment, the transparent conductive layer 210 can lead out charges carried by the static electricity or the conductive body via the ground terminal 110, so as to avoid the influence of the charges carried by the static electricity or the conductive body on the display of the LCD panel, and hence prevent the charges carried by the static electricity or the conductive body from damaging electronic devices or circuits in the LCD panel. It should be noted that FIG. 4 and the above relevant description only take one side of the LCD panel as an example, and obviously, other sides of the LCD panel may also be provided with the conductive adhesive so as to achieve the connection between the transparent conductive layer and the ground terminal. In addition, as the shortest distance between the outer edge of the BM pattern 203 disposed in the peripheral region 80 and the outer edge of the opposed substrate 200 is greater than 0 and less than or equal to 0.15 mm, the conductive adhesive 310 will not connect the BM pattern and the ground terminal.

For instance, the conductive adhesive may include silver conductive adhesive.

### A Second Embodiment

The embodiment provides a method for manufacturing an LCD panel. As illustrated in FIG. 5, the manufacturing method comprises the following steps S201-S203.

S201: providing an array substrate, in which the array substrate includes a first base substrate and a common electrode pattern disposed on the first base substrate.

S202: providing an opposed substrate, in which the opposed substrate includes a second base substrate and a BM pattern disposed on the second base substrate.

S203: cell-assembling the array substrate and the opposed substrate, and electrically connecting the common electrode pattern and the BM pattern.

In the method for manufacturing the LCD panel, provided by the embodiment, the common electrode pattern is electrically connected with the BM pattern, so the BM pattern and the common electrode pattern have same electric potential. That is to say, when a common electrode voltage is applied to the common electrode pattern, a voltage of the BM pattern has same potential with the common electrode voltage. Thus, no electric field will be produced between the BM pattern and the common electrode pattern, so that the problem of abnormal color or flicker of an image of the LCD panel can be avoided. It should be noted that the above method for manufacturing the LCD panel may comprise the step of manufacturing the array substrate or the opposed substrate, and may also utilize the conventional array substrate and the conventional opposed substrate for further production.

For instance, in the method for manufacturing the LCD panel, provided by one example of the embodiment, as shown in FIG. 3, the array substrate 100 further includes a pixel electrode pattern 106 disposed on the first base substrate 101 and an insulating layer 107 disposed between the common electrode pattern 108 and the pixel electrode pattern 106. The common electrode pattern 108 is disposed on a side of the insulating layer 107 close to the opposed substrate 200. The description on the specific technical effects may refer to relevant description in the first embodiment, so no further description will be given here.

For instance, in the method for manufacturing the LCD panel, provided by one example of the embodiment, as shown in FIG. 3, the LCD panel includes a display region 90 and a peripheral region 80 disposed at the periphery of the display region 90. The manufacturing method further comprises: coating a sealant 400 in the peripheral region 80 of the array substrate 100 and the opposed substrate 200 to seal a liquid crystal cell 300 formed by the array substrate 100 and the opposed substrate 200. The sealant 400 includes a conductive structure 450. The common electrode pattern 108 and the BM pattern 203 are electrically connected with each other through the conductive structure 450. The description on the specific technical effects may refer to relevant description in the first embodiment, so no further description will be given here.

For instance, in the method for manufacturing the LCD panel, provided by one example of the embodiment, as shown in FIG. 3, the conductive structure 450 is a conductive metal ball.

For instance, in the method for manufacturing the LCD panel, provided by one example of the embodiment, the conductive metal ball is an Au ball.

For instance, in the method for manufacturing the LCD panel, provided by one example of the embodiment, as shown in FIG. 3, a covering layer 204 is disposed on a side of the BM pattern 203 close to the array substrate 100. The manufacturing method comprises: etching the covering layer 204 in the peripheral region 80 to expose the BM pattern 203. For instance, as shown in FIG. 3, the common electrode pattern 108 includes a common electrode 1080 and a common electrode line 1081 connected with the common electrode 1080; and the BM pattern 203 includes a peripheral BM 2031 disposed in the peripheral region 80 of the LCD panel and a display region BM 2030 disposed in the display region 90 of the LCD panel. The covering layer 204 in a region to be coated with the sealant 400 is etched by a mask process to completely remove the covering layer 204 in the region, and then the sealant 400 comprising the conductive structure 450 (e.g., an Au ball) is coated. Thus, the common electrode line 1081 and the peripheral BM 2031, disposed in the peripheral region 80 of the LCD panel, are connected with each other through the conductive structure 450, so as to achieve the electrical connection between the BM pattern 203 and the common electrode pattern 108. Therefore, the problem of abnormal color or flicker of an image of the LCD panel due to the voltage difference between the BM pattern having other electric potentials (zero potential or high potential) and the common electrode pattern can be avoided. It should be noted that the embodiment of the present invention includes but not limited thereto, and the BM pattern and the common electrode pattern may also be electrically connected with each other by other means, for instance, connected with each other through a leading wire.

For instance, the method for manufacturing the LCD panel, provided by one example of the embodiment, further comprises: cutting peripheral parts of the BM pattern. As shown in FIG. 3, the shortest distance between an outer edge of the BM pattern 203 obtained after cutting and an outer edge of the opposed substrate 200 is greater than 0 and less than or equal to 0.15 mm. Thus, there is certain distance from the BM pattern 203 to an edge of the LCD panel, so as to further avoid the interference of static electricity or conductive bodies from the outside.

For instance, the method for manufacturing the LCD panel, provided by one example of the embodiment, further comprises: as shown in FIG. 4, forming a transparent conductive layer 210 on a side of the second base substrate 201 away from the array substrate 100; forming a ground terminal 110 on the array substrate 100; and coating a conductive adhesive 310 on surrounding edges of the array substrate 100 and the opposed substrate 200, so as to connect the transparent conductive layer 210 and the ground terminal 110. Thus, when static electricity or a conductive body makes contact with the LCD panel manufactured by the method for manufacturing the LCD panel, provided by the embodiment, the transparent conductive layer 210 may lead out charges carried by the static electricity or the conductive body through the ground terminal 110, so as to avoid the influence of the charges carried by the static electricity or the conductive body on the display of the LCD panel, and hence prevent the charges carried by the static electricity or the conductive body from damaging electronic devices or circuits in the LCD panel.

### A Third Embodiment

The embodiment provides a display device, which comprises any LCD panel provided by the first embodiment. Therefore, the display device has the technical effects corresponding to the technical effects of the LCD panel in the first embodiment. The specific description on the display device may refer to relevant description in the first embodiment. No further description will be given here.

The display device provided by the embodiment of the present invention may be: any product or component with display function such as e-paper, a display, a mobile phone, a tablet PC, a TV, a notebook computer, a digital picture frame and a navigator.

The following points should be noted:

(1) The accompanying drawings in the embodiments of the present invention only involve structures relevant to the embodiments of the present invention, and other structures may refer to the prior art.

(2) For clarity, in the accompanying drawings of the embodiments of the present invention, the thickness and the size of layers or microstructures are enlarged. It should be understood that: when an element such as a layer, a film, a region or a substrate is referred to as being disposed “on” or “beneath” another element, the element may be “directly” disposed “on” or “beneath” another element, or an intermediate element may be provided.

(3) The characteristics in the same embodiment or different embodiments of the present invention may be mutually combined without conflict.

The foregoing is only the embodiments of the present invention and not intended to limit the scope of protection of the present invention. The scope of protection of the present invention should be defined by the appended claims.

The application claims priority to the Chinese patent application No. 201610543701.9, filed Jul. 11, 2016, the disclosure of which is incorporated herein by reference as part of the application.

1. A liquid crystal display (LCD) panel, comprising:
an array substrate, including a first base substrate and a common electrode pattern disposed on the first base substrate; and
an opposed substrate, arranged opposite to the array substrate and including a second base substrate and a black matrix (BM) pattern disposed on the second base substrate,
wherein the common electrode pattern is electrically connected with the BM pattern.

2. The LCD panel according to claim 1, wherein materials of the BM pattern include conductive materials.

3. The LCD panel according to claim 1, wherein the array substrate further includes a pixel electrode pattern disposed on the first base substrate and an insulating layer disposed between the common electrode pattern and the pixel electrode pattern, and a common electrode is disposed on a side of the insulating layer close to the opposed substrate.

4. The LCD panel according to claim 1, wherein the LCD panel includes a display region and a peripheral region disposed at a periphery of the display region; and the LCD panel further comprises:
a sealant, disposed between the array substrate and the opposed substrate in the peripheral region,
wherein the sealant includes a conductive structure, and the common electrode pattern is electrically connected with the BM pattern through the conductive structure.

5. The LCD panel according to claim 4, wherein the conductive structure is a conductive metal ball.

6. The LCD panel according to claim 5, wherein the conductive metal ball is a gold (Au) ball.

7. The LCD panel according to claim 4, wherein the common electrode pattern includes a common electrode and a common electrode line, and the common electrode line is electrically connected with the BM pattern through the conductive structure.

8. The LCD panel according to claim 4, wherein a shortest distance between an outer edge of the BM pattern in the peripheral region and an outer edge of the opposed substrate is greater than 0 and less than or equal to 0.15 mm.

9. The LCD panel according to claim 8, wherein the opposed substrate further includes a transparent conductive layer disposed on a side of the second base substrate away from the array substrate,
the first base substrate also includes a ground terminal,
the LCD panel further comprises a conductive adhesive disposed on surrounding edges of the opposed substrate and the array substrate, and the transparent conductive layer is connected with the ground terminal through the conductive adhesive.

10. The LCD panel according to claim 4, wherein the opposed substrate further includes:
a covering layer disposed on the BM pattern,
wherein in the peripheral region, the covering layer is provided with a through hole or is completely removed to expose the BM pattern.

11. A method for manufacturing an LCD panel, comprising:
providing an array substrate, the array substrate includes a first base substrate and a common electrode pattern disposed on the first base substrate;
providing an opposed substrate, the opposed substrate includes a second base substrate and a BM pattern disposed on the second base substrate; and
cell-assembling the array substrate and the opposed substrate, and electrically connecting the common electrode pattern and the BM pattern.

12. The method for manufacturing the LCD panel according to claim 11, wherein the LCD panel includes a display region and a peripheral region disposed at a periphery of the display region,
and the manufacturing method further comprises:
coating a sealant on the peripheral regions of the array substrate and the opposed substrate to seal a liquid crystal cell formed by the array substrate and the opposed substrate,
wherein the sealant includes a conductive structure, and the common electrode pattern is electrically connected with the BM pattern through the conductive structure.

13. The method for manufacturing the LCD panel according to claim 12, wherein the conductive structure is a conductive metal ball.

14. The method for manufacturing the LCD panel according to claim 13, wherein the conductive metal ball is an Au ball.

15. The method for manufacturing the LCD panel according to claim 12, wherein a covering layer is disposed on a side of the BM pattern close to the array substrate,
and the manufacturing method comprises:
etching the covering layer in the peripheral region to expose the BM pattern.

16. The method for manufacturing the LCD panel according to claim 11, wherein the array substrate further includes a pixel electrode pattern disposed on the first base substrate and an insulating layer disposed between the pixel electrode pattern and the common electrode pattern, and a common electrode is disposed on a side of the insulating layer close to the opposed substrate.

17. The method for manufacturing the LCD panel according to claim 11, further comprising:
cutting a peripheral part of the BM pattern,
wherein a shortest distance between an outer edge of the BM pattern obtained after cutting and an outer edge of the opposed substrate is greater than 0 and less than or equal to 0.15 mm.

18. The method for manufacturing the LCD panel according to claim 17, further comprising:
forming a transparent conductive layer on a side of the second base substrate away from the array substrate;
forming a ground terminal on the array substrate; and
coating a conductive adhesive on surrounding edges of the array substrate and the opposed substrate to connect the transparent conductive layer and the ground terminal.

19. A display device, comprising the LCD panel according to claim 1.
